(19) United States
(12) Patent Application Publication
(10) Pub. No.: US 2022/0335157 A1
(43) Pub. Date: Oct. 20, 2022

(54) SYSTEM AND METHOD FOR PROCESSING PERSONAL DATA

(71) Applicant: IDEMIA IDENTITY & SECURITY FRANCE, Courbevoie (FR)

(72) Inventors: Hervé CHABANNE, Courbevoie (FR); Jean-Christophe FONDEUR, Courbevoie (FR); Yannick COURQUIN, Courbevoie (FR)

(21) Appl. No.: 17/658,757

(22) Filed: Apr. 11, 2022

(30) Foreign Application Priority Data
Apr. 15, 2021 (FR) 2103918

(51) Int. Cl. G06F 21/62; H04L 9/00

(52) U.S. Cl. CPC G06F 21/6245; H04L 9/008

(57) ABSTRACT

The invention proposes a personal data processing system (1) comprising a data storage module (12) storing an encrypted reference personal data database, wherein it further comprises a hardware security module (10) storing a private key for decryption of said reference personal data and configured to implement data filtering preventing any output of personal data. The invention further provides a method for processing personal data.

### CROSS-REFERENCE TO RELATED APPLICATIONS

This application claims priority pursuant to 35 U.S.C. 119(a) to France Patent Application No. 2103918, filed Apr. 15, 2021, which application is incorporated herein by reference in its entirety.

### TECHNICAL FIELD OF THE INVENTION

The invention relates to a method for processing personal data, for the comparison between candidate personal data and at least one reference personal data.

### STATE OF THE ART

Identification or authentication schemes are already known wherein a user presents to a trusted processing unit, for example a unit belonging to a customs office, an airport, etc., newly acquired biometric data on the user that the unit matches with one or more reference biometric data stored in a database to which it has access.

This database aggregates the biometric reference data of authorized individuals (such as passengers on a flight before boarding).

Such a solution is satisfactory, but raises the problem of the confidentiality of the reference biometric database in order to guarantee user privacy.

To avoid any unencrypted manipulation of the biometric data, it is possible to use a homomorphic encryption and to implement the processing operations on the biometric data (typically distance calculations) in the encrypted domain. A homomorphic cryptographic system makes it possible to perform certain mathematical operations on previously encrypted data instead of unencrypted data. Thus, for a given calculation, it becomes possible to encrypt the data, perform certain calculations associated with said given calculation on the encrypted data, and decrypt them, obtaining the same result as if said given calculation had been performed directly on the unencrypted data.

Thus the custodian of the private key of the homomorphic cryptographic system can then obtain the desired result of identification or authentication of an individual.

However, even if this custodian is a trusted entity, they have the ability to decrypt the biometric data with this key, which remains problematic.

It would thus be desirable to have a simple, reliable, secure and fully privacy-compliant solution for identifying/authenticating an individual.

### BRIEF DESCRIPTION OF THE INVENTION

According to a first aspect, the invention relates to a personal data processing system comprising a data storage module storing a reference personal database encrypted in a homomorphic manner, said system being characterized in that it further comprises a hardware security module storing a private key for decryption of said reference personal data and configured to implement data filtering preventing any output of personal data.

According to advantageous and non-limiting characteristics:
Said filtering is carried out on the input data of said hardware security module, and blocks any personal data.
Said hardware security module is configured to decrypt the input data of said hardware security module using said private decryption key, and then carry out filtering on the decrypted input data.
Said filtering is carried out on the basis of at least one range of authorized or prohibited input data values, at least one range of authorized or prohibited input data sizes, and/or at least one authorized or prohibited input data format.
Said hardware security module is further configured to return at least one data representative of the result of a comparison between at least one reference personal data of said database and one candidate personal data.
Said personal data are biometric data, the system further comprising biometric acquisition means for obtaining said candidate biometric data.

The method further comprises a data processing module configured to implement in the encrypted domain said comparison between at least one reference personal data and the candidate personal data, said hardware security module being configured to decrypt the result of said comparison using said private decryption key.

The result of said comparison between at least one reference personal data and the candidate personal data is a distance score between at least one reference personal data and the candidate personal data, in particular their scalar product; the generation of said data representative of the result of the comparison between at least one reference personal data and one candidate personal data comprising the normalization and/or thresholding of said distance score.

Said candidate personal data is encrypted in the same homomorphic way as the reference personal data.

Said hardware security module is further configured to trigger an alarm if said filtering blocks data and/or if input data is incorrectly encrypted.

Said security hardware module is an enclave of a data processing module of the system.

According to a second aspect, the invention relates to a method of processing personal data carried out by a system comprising a data processing module and a data storage module storing a database of reference personal data encrypted in a homomorphic manner;
characterized in that said system further comprises a hardware security module storing a private key for decrypting said reference personal data and configured to implement data filtering preventing any output of personal data; and
characterized in that it comprises steps of:
(a) Comparison in the domain encrypted by said data processing module of one candidate personal data with at least one reference personal data;
(b) Decryption of the result of said comparison by said hardware security module using said private decryption key.

According to advantageous and non-limiting characteristics:
Said personal data are biometric data, the method comprising a step (a0) of obtaining candidate biometric data from a biometric trait using biometric acquisition means of the system.
The method further comprises a step (c) of implementing an access control based on data representative of the result of said comparison generated by said hardware security module based on said result of the comparison between the candidate personal data and at least one reference personal data.

According to a third and a fourth aspect, the invention relates to a computer program product comprising code instructions for the execution of a method according to the second aspect of processing personal data; and a storage means readable by a computer equipment on which a computer program product comprises code instructions for the execution of a method according to the second aspect of processing personal data.

### BRIEF DESCRIPTION OF THE FIGURES

Other characteristics, purposes and advantages of the present invention will be seen from the following detailed description with regard to the appended figures, provided by way of non limiting example, and wherein:

FIG. 1 schematically represents a preferred embodiment of a system according to the invention;

FIG. 2 illustrates the steps of an embodiment of a method according to the invention.

### DETAILED DESCRIPTION

### Architecture

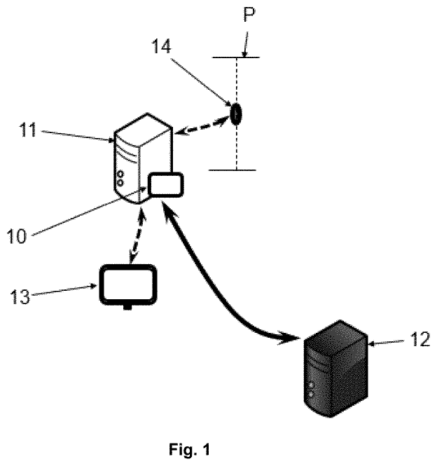

With reference to FIG. 1, a system for processing personal data for the authentication/identification of individuals is schematically represented.

This system 1 is a piece of equipment owned and controlled by an entity with which the authentication/identification must be performed, for example a government entity, customs, an organization, etc. In the rest of the present description, the example of an airport will be taken, with the system 1 typically aiming to control the access of passengers on a flight before boarding.

By personal data, biometric data is meant in particular (and this example will be used in the rest of the present description), but it will be understood that this may be any data specific to an individual on the basis of which it is possible to authenticate a user, such as alphanumeric data, a signature, etc.

Conventionally, the system 1 comprises a data processing module 11, i.e. a computer such as for example a processor, a microprocessor, a controller, a microcontroller, an FPGA, etc. This computer is suitable for executing code instructions to implement, if necessary, part of the data processing that will be presented below.

The system 1 also comprises a data storage module 12 (a memory, for example flash) and advantageously a user interface 13 (typically a screen), and biometric acquisition means 14 (see below).

In addition, the system 1 is distinguished in that it comprises a hardware security module 10 [module matériel de sécurité], which in English is “Hardware Security Module” or simply HSM (in French the name “Boîte noire transactionnelle” or BNT is also used). It is an apparatus considered tamper-proof offering cryptographic functions, which can be for example a PCI plug-in electronic card on a computer or an external SCSI/IP box, but also a secure enclave of the data processing module 11.

The system 1 may be provided locally (for example in the airport), but can be separated into one or even more remote “cloud” servers hosting the electronic components (modules 10, 11, 12) connected to the biometric acquisition means 14 that must necessarily remain on site (at the gate for boarding control). In the example of FIG. 1, storage module 12 is remote.

In the preferred biometric embodiment, the system 1 is capable of generating so-called candidate biometric data from a biometric trait of an individual. The biometric trait can for example be the shape of the face, one or more fingerprints, or one or more irises of the individual. The extraction of the biometric data is achieved by processing the image of the biometric trait, which depends on the nature of the biometric trait. Methods for processing a variety of images in order to extract biometric data are known to the person skilled in the art. As a non-limiting example, the extraction of the biometric data can comprise an extraction of a representative template (in particular by a neural network), of particular points, or of a shape of the face in the case wherein the image is an image of the face of the individual.

The biometric acquisition means 14 therefore typically consist of an image sensor, for example a digital still apparatus or a digital camera, suitable for acquiring at least one image of a biometric trait of an individual, see below.

In general, there will always be one candidate personal data and at least one reference personal data to compare, if alphanumeric personal data is used the candidate data can be simply entered on the means 13 or for example obtained by optical reading from an image.

Data storage module 12 stores a reference personal database, i.e. at least one personal data “expected” of an authorized individual, for example the passengers registered for the flight. Each reference personal data is advantageously a data recorded in an identity document of the individual. For example, the personal data can be the biometric data obtained from an image of the face appearing on an identity document (for example a passport), or even an image of the face, of at least one fingerprint, or at least one iris of the individual recorded in a radiofrequency chip contained in the document.

Each reference personal data is stored encrypted, preferably by means of an asymmetric cryptosystem, in particular homomorphic (we will come back to this later). There is a pair of a private decryption key stored (preferably only) in said hardware security module 10, and a public encryption key. Any cryptosystem with the requested properties can be used, for example RSA which is partially homomorphic, Boneh-Goh-Nissim which is almost completely homomorphic, or Brakerski-Gentry-Vaikuntanathan (BGV), Cheon-Kim-Kim-Son (CKKS), Fast Fully Homomorphic Encryption Over the Torus (TFHE) or Brakerski/Fan-Vercauteren (BFV) which are fully homomorphic (FHE, Fully Homomorphic Encryption).

It is assumed that the reference personal data database is established in advance. For example, passengers may have presented their identity document in advance.

In one embodiment, the system 1 carries out an authentication of the individual, that is compares the so-called candidate personal data (newly acquired on the individual in the case of biometric data, or otherwise simply requested from the individual if it is alphanumeric data for example), to a single reference personal data, supposed to come from the same individual, in order to verify that the individual from which the two data were obtained is indeed the same.

In another embodiment, the system 1 carries out identification of the individual, that is compares the candidate personal data with all the reference personal data of said base, in order to determine the identity of the individual.

The system 1 can finally include access control means (for example an automatic gate P in FIG. 1) controlled based on the result of the authentication/identification: if an authorized user is recognized, access is authorized. Said biometric acquisition means 14 can be directly mounted on said access control means.

### Hardware Security Module

The present invention proposes to cleverly use the hardware security module 10 to completely control access to personal data.

The idea is to configure this hardware security module 10 to implement data filtering preventing any output of personal data, or even any input of encrypted personal data, and in general any manipulation of personal data once decrypted.

It is understood that by “preventing any input of personal data”, it is meant in practice prohibiting the acceptance of such personal data in the HSM 10, i.e. blocking them. Of course, data must be read by the HSM 10 in order to be filtered, but the HSM 10 can be configured so that it will only allow itself to continue to process them if the filtering is successful (i.e. they are not personal data). In other words, a blocked input data will minimally enter the HSM 10, before being deleted, see below.

Indeed, only the latter has the decryption key: storage module 12 is in itself accessible, but the reference personal data are stored therein in an encrypted manner.

The hardware security module 10 has the ability to decrypt them, but the filtering rule prevents it from communicating them outwardly, or even from accepting them, so that their confidentiality is guaranteed.

More precisely, a third party that would have fraudulently accessed the system 1 can send all the commands it wants to the hardware security module 10 but the filtering will always prevent it from producing this data in unencrypted form. In addition, the inviolable nature of the HSMs means that the filtering rule cannot be deactivated without destroying the hardware security module 10 and losing the decryption key and therefore any hope of access to the reference data.

Filtering, however, does not prevent any input/output of data, so that, nevertheless, it is possible to obtain from the hardware security module 10 the result of an operation on the personal data without violating the confidentiality thereof, for example, a Boolean of belonging or not to the base or a trust score.

More precisely, said hardware security module 10 can also be configured to return at least one data representative of the result of a comparison between at least one reference personal data and one candidate personal data. If it is desired to identify the individual, a comparison can be made of each reference personal data of the base and the candidate personal data (i.e. as many comparisons with the candidate data as reference data). It will later be seen how this works, and one shall not confuse the notion of “comparison between two personal data” (which corresponds in practice to a calculation of a distance score) and the notion of “comparison of a score with a threshold” (i.e. thresholding).

As explained, the filtering is preferably filtering of the input data (inputs) of said hardware security module 10 preventing any input of encrypted personal data, even if it could also be filtering of the output data (outputs). The filtering of the input data is the most secure because if personal data were nevertheless sent to module 10, it prevents any subsequent manipulation of this data within module 10 and therefore any potential leakage.

For this, said hardware security module 10 is configured to decrypt the input data using said private decryption key, then implement (directly) the filtering on the decrypted input data. In other words, module 10 immediately ensures that it has the right to work on the data provided. If it finds that the decrypted data is personal data, it blocks it (all traces of it are removed from the HSM 10), and if not, it allows further processing. In other words, the HSM 10 is configured to systematically implement the following sequence on each input data:
Decrypting the input data;
Determining whether the decrypted input data is personal data or not;
If the decrypted input data is personal data, blocking it, and optionally triggering an alarm (note that the alarm can also be triggered if the input data is “incorrectly encrypted”, i.e. if the HSM 10 fails to perform decryption and thus to obtain decrypted input data).

In the case of filtering on the output, this is implemented whenever the HSM 10 needs to execute a command for outputing data to the outside. In other words, the HSM 10 is configured to systematically implement the following sequence on each data for which its output is required:
Determining whether the data whose output is required is personal data or not;
If (and only if) the data whose output is required is not personal data, performing its output from the HSM. Otherwise, blocking it, and optionally triggering an alarm.

Said filtering is preferentially carried out on the basis of at least one range of authorized input data values, of at least one range of authorized input data sizes, and/or at least one authorized input data format. Conversely, it may be at least one range of prohibited input data values, at least one range of prohibited input data sizes, and/or at least one prohibited input data format (it will be understood that there is an equivalence between the two representations). It should be noted that we can see the same rules on the output data if the filtering is at this level.

For example:
“Boolean” type;
Ranges {0} and {1} for a Boolean result;
“Integer” type and range [0; 100] for a score;
Etc.

If the filtering concludes that the input data is authorized, or at least not prohibited, the hardware security module 10 can implement the intended processing of the input data.

### Candidate Personal Data

It is important to understand that if the enrollment, that is the constitution of the reference personal data base, can be carried out well before the personal comparison, in the biometric case the candidate data must be obtained in the worst case a few minutes before, to guarantee the “freshness” of this candidate data.

As explained, the system 1 further comprises biometric acquisition means 14 for obtaining said candidate biometric data. Generally, the candidate biometric data is generated by the data processing module 11 from a biometric trait supplied by the biometric acquisition means 14, but the biometric acquisition means 14 can comprise their own processing means and for example take the form of an automatic device provided by the control authorities (in the airport) to extract the candidate biometric data. Such a device can, if necessary, encrypt the candidate biometric data on the fly, advantageously with the public encryption key corresponding to the private decryption key of the hardware security module 10. Thus, the candidate biometric data is also completely protected.

Preferably, the biometric acquisition means 14 are capable of detecting living beings, so as to ensure that the candidate biometric data comes from a “real” trait.

In the case where the means 14 and the rest of the system are remote, the communication between the two can itself be encrypted.

In all cases, the comparison between the candidate personal data and a reference personal data can be carried out in any known way, in particular the candidate personal data and the reference personal data coincide if their distance according to a given comparison function is below a predetermined threshold.

Thus, the implementation of the comparison comprises the calculation of a distance between the data, the definition of which varies based on the nature of the personal data considered. The calculation of the distance comprises the calculation of a polynomial between the components of the biometric data, and advantageously, the calculation of a scalar product.

For example, in the case of biometric data obtained from iris images, a distance conventionally used to compare two data is the Hamming distance. In the case where it is biometric data obtained from images of the face of an individual, it is common to use the Euclidean distance.

This type of comparison is known to the person skilled in the art and will not be described in more detail hereinafter.

The individual is authenticated if the comparison reveals a similarity rate between the candidate data and the “target” reference data exceeding a certain threshold, the definition of which depends on the calculated distance. In such an embodiment, the hardware security module 10 can return the Boolean depending on whether the threshold is exceeded, or else the similarity rate directly, in particular if it is greater than the threshold. The similarity rate can be any score calculated from said distance, for example a discrete “level” of distance to limit the amount of information, or else a normalized, or even slightly noisy, version of the distance). In the remainder of the present description, the “distance score” will be used generically, which could for example be a value between 0 (totally different personal data) and 100 (totally identical personal data).

In the case of an identification, the hardware security module 10 can return for example the Boolean depending on whether the threshold is exceeded for at least one reference data, the different similarity rates/scores associated with each reference data in particular those greater than the threshold, or the identifiers of the piece or pieces of reference data for which the similarity rate exceeds said threshold, and again any other possible score.

For other types of personal data, for example alphanumeric data, the reference data and the candidate data must be identical, so that a Boolean can be returned directly indicating whether this is the case.

In general, any data representative of the result of the comparison can be used as output data from the hardware security module 10, as long as the personal data remains inaccessible.

### Homomorphic Encryption

It may seem paradoxical that the hardware security module 10 is the only one to have the private key for decrypting the reference personal data but does not have the right to accept the encrypted reference personal data, but herein we are in fact cleverly using the properties of homomorphic encryption.

The idea is to use the simple data processing module 11 to directly implement in the encrypted domain said comparison between at least one reference personal data and the candidate personal data. In other words, the data processing module 11 works on encrypted data and obtains a result (typically a distance score between the reference personal data and the candidate personal data) which is itself encrypted and therefore unusable.

It is recalled that it is indeed a property of homomorphic encryption to be able to “switch” with certain operations, for example addition and multiplication in the case of a fully homomorphic encryption (FHE), which makes it possible for example to implement a scalar product, i.e. a distance calculation.

Said hardware security module 10 is for its part configured to decrypt the result of said comparison using said private decryption key, which is consistent with filtering, then process it so as to obtain another data representative of the result of said comparison, typically by normalization and/or comparison with a threshold. In general, this data representative of the result of said comparison is a result of identification/authentication of the individual, i.e. typically a Boolean of belonging to the base or at least one distance score, in particular those above said threshold. This embodiment makes it possible for the hardware security module 10 to avoid any manipulation of personal data, and is very light in computational terms for the hardware security module 10, since it is the conventional module 11 that does most of the work.

It should be noted that said candidate personal data must be encrypted in the same way (homomorphic) as the piece or pieces of reference personal data in order to be able to implement the comparison in the encrypted domain.

Thus, said data processing module 11 (or the biometric acquisition processing means 14 if they have the ability) is advantageously further configured to encrypt said candidate personal data using a public encryption key (corresponding to the private decryption key).

It should be noted that said data representative of the result of the comparison may directly be this result of the comparison (the distance score), and the hardware security module 10 can simply return it, but as explained, other processing operations have preferably been carried out on this data by module 10, such as for example its normalization and/or its comparison with a threshold, and/or the combination of the distance scores associated with several reference data to “hide” the result of the comparison if these treatments are not already done in processing module 11.

### Method for Processing Personal Data

It will be understood that according to a second aspect, the invention generally relates to any personal data processing method carried out by said personal data processing system 1 according to the first aspect of the invention. It suffices for the hardware security module 10 to be able to return (in unencrypted form) the result of said comparison.

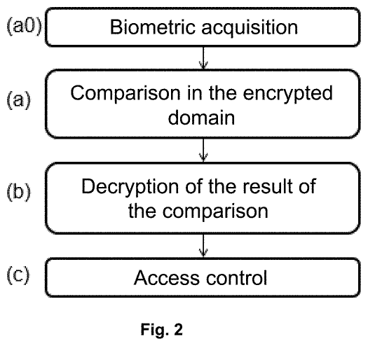

With reference to FIG. 2, said processing method of personal data advantageously begins, if the personal data is biometric data, with a preliminary step (a0) of obtaining the candidate biometric data from a biometric trait using the biometric acquisition means 14 of the system 1.

Then, in a step (a), the method comprises the comparison in the domain encrypted by said data processing module 11 of a candidate personal data with at least one reference personal data (said result of said comparison typically being a distance score between the candidate personal data and each reference personal data).

The method then comprises in a step (b), the decryption of said result of said comparison by said hardware security module 10 using said private decryption key, and preferably its processing so as to generate descriptive data of the result of the comparison between at least one reference personal data and the candidate personal data (result of identification/authentication of the individual), such as a Boolean of belonging to the base or the scores above a threshold if the results of comparisons are distance scores. As explained, this step (b) typically comprises the normalization and/or the thresholding of a decrypted comparison result (a distance score) by the hardware security module 10 so as to generate said descriptive data of the result of the comparison.

Also, the method advantageously further comprises a step (c) of implementing an access control based on said data representative of the result of said comparison. In other words, if the individual to whom the candidate personal data belongs has been correctly identified/authenticated, he or she is “authorized” and other actions such as the opening of the automatic gate P may occur.

### Computer Program Product

According to a third and a fourth aspect, the invention relates to a computer program product comprising code instructions for the execution (in particular on the data processing module 11 and/or the hardware security module 10 of the system 1) of a method according to the second aspect of the invention, as well as storage means readable by computer equipment (a data storage module 12 of the system 1 and/or a memory space of the hardware security module 10) on which this computer program product is found.

What is claimed is:

1. A personal data processing system comprising a data storage module storing a reference personal data base encrypted in an homomorphic manner, said system being wherein it further comprises a hardware module security system storing a private key for decryption of said reference personal data and configured to carry out data filtering preventing any output of personal data.

2. The system according to claim 1, wherein said filtering is carried out on the input data of said hardware security module, and blocks any personal data.

3. The system according to claim 2, wherein said hardware security module is configured to decrypt the input data of said hardware security module using said private decryption key, then carrying out filtering on the decrypted input data.

4. The system according to claim 3, wherein said filtering is carried out based on at least one range of authorized or prohibited input data values, on at least one range of authorized or prohibited input data sizes, and/or on at least one authorized or prohibited input data format.

5. The system according to claim 1, wherein said hardware security module is further configured to return at least one piece of data representative of the result of a comparison between at least one piece of reference personal data from said base and candidate personal candidate.

6. The system according to claim 5, wherein said personal data are biometric data, the system further comprising biometric acquisition means for obtaining said candidate biometric data.

7. The system according to claim 5, further comprising a data processing module configured to implement in the encrypted domain said comparison between the at least one reference personal data and the candidate personal data, said hardware security module being configured to decrypt the result of said comparison using said private decryption key.

8. The system according to claim 7, wherein the result of said comparison between the at least one reference personal data and the candidate personal data is a distance score between the at least one reference personal data and the candidate personal data, in particular their scalar product; the generation by said hardware security module of said piece of data representative of the result of the comparison between at least one reference personal data and one candidate personal data comprising the normalization and/or thresholding of said distance score.

9. The system according to claim 5, wherein said candidate personal data is encrypted in the same homomorphic manner as the reference personal data.

10. The system according to claim 1, wherein said security hardware module is further configured to trigger an alarm if said filtering blocks data and/or if input data is incorrectly encrypted.

11. A method for processing personal data carried out by a system comprising a data processing module and a data storage module storing a database of reference personal data encrypted in a homomorphic manner;
wherein said system further comprises a hardware security module storing a private key for decrypting said reference personal data and configured to implement data filtering preventing any output of personal data; and
wherein it comprises steps of:
(a) Comparison in the domain encrypted by said data processing module of one candidate personal data with at least one reference personal data;
(b) Decryption of the result of said comparison by said hardware security module using said private decryption key.

12. The method according to claim 11, wherein said personal data is biometric data, the method comprising a step (a0) of obtaining candidate biometric data from a biometric trait using biometric acquisition means of the system.

13. The method according to claim 11, further comprising a step (c) of implementing an access control based on data representative of the result of said comparison generated by said hardware security module based on said result of the comparison between the candidate personal data and at least one reference personal data.

14. A computer program product comprising code instructions for executing a method according to claim 11 for processing personal data, whereupon said method is executed on a computer.

15. A storage means readable by computer equipment on which a computer program product comprises code instructions for the execution of a method according to claim 11 for processing personal data.
